(19) United States
(12) Patent Application Publication
(10) Pub. No.: US 2012/0044527 A1
(43) Pub. Date: Feb. 23, 2012

(54) Apparatus and Method for Controlled Ethernet Switching

(75) Inventor: James A. Panko, Wonder Lake, IL (US)

(73) Assignee: SNAP-ON INCORPORATED, Kenosha, WI (US)

(21) Appl. No.: 13/189,940

(22) Filed: Jul. 25, 2011

Related U.S. Application Data
(60) Provisional application No. 61/374,696, filed on Aug. 18, 2010.

(51) Int. Cl. G06F 15/00

(52) U.S. Cl. 358/1.15

(57) ABSTRACT

Methods, devices, and computer-readable media related to use of a scanner device and access node to repair a device-under-repair are disclosed. The first and second connections can utilize a first communication protocol (e.g., Ethernet or Bluetooth) and the third connection can utilize a different second communication protocol (e.g., OBD-II). In response to receiving a first communication addressed to a first address, the first communication can be sent from the scanner device via the second connection. In response to receiving a second communication addressed to a second address, where the first address differs from the second address, the second communication can be converted to conform to the second communication protocol and the converted second communication can be sent from the scanner device via the third connection.

### CROSS REFERENCE TO RELATED APPLICATIONS

This application claims priority to U.S. Patent Application No. 61/374,696, filed Aug. 18, 2010, entitled “Apparatus and Method for Controlled Ethernet Switching”, the contents of which are fully incorporated herein by reference.

### BACKGROUND

Vehicles, such as automobiles, light-duty trucks, and heavy-duty trucks, play an important role in the lives of many people. To keep vehicles operational, some people rely on vehicle technicians to diagnose and repair their vehicles.

Vehicle technicians use a variety of tools in order to diagnose and/or repair vehicles. Those tools can include common hand tools, such as wrenches, hammers, pliers, screwdrivers and socket sets, or more vehicle-specific tools, such as cylinder hones, piston ring compressors, and vehicle brake tools. The tools used by vehicle technicians can also include electronic tools such as a digital voltage-ohm meter (DVOM) or a vehicle scan tool that communicates with an electronic control unit (ECU) within a vehicle.

Vehicle technicians can work at various locations of a vehicle in order to diagnose and/or repair the vehicle. For example, while working on an automobile having a passenger compartment and an under-hood area containing an internal combustion engine, a vehicle technician can desire to work at the under-hood area and at the passenger compartment. For example, the vehicle technician can desire to use a DVOM to make a voltage measurement at the under-hood area while the technician operates user controls within the passenger compartment so as to re-create a vehicle performance complaint (e.g., a cylinder misfire).

### Overview

Various example embodiments are described in this description. In one respect, an example embodiment can take the form of a method. At least first, second, and third connections can be established at a scanner device. The first and second connections can utilize a first communication protocol and the third connection can utilize a second communication protocol. The first communication protocol can be different from the second communication protocol. A first communication addressed to a first address can be received via the first connection. In response to receiving the first communication addressed to the first address, at least part of the first communication can be sent from the scanner device via the second connection. A second communication addressed to a second address can be received. The first address can be different from the second address. In response to receiving the second communication addressed to the second address: (a) the second communication can be converted to conform to the second communication protocol, and (b) the converted second communication can be sent from the scanner device via the third connection.

In a second respect, an example embodiment can take the form of a scanner device that includes a processor, memory, a communication interface and computer-readable program instructions. The computer-readable program instructions can be stored in the memory. Upon execution by the processor, the instructions can cause the device to perform functions. The functions can include: (a) establishing, via the communication interface, at least first, second, and third connections, where the first and second connections utilize a first communication protocol and the third connection utilizes a second communication protocol, and where the first communication protocol differs from the second communication protocol, (b) receiving a first communication addressed to a first address via the first connection, (c) in response to receiving the first communication addressed to the first address, sending at least part of the first communication via the second connection, (d) receiving a second communication addressed to a second address via the first connection, where the first address differs from the second address, and (e) in response to receiving the second communication addressed to the second address: (i) converting the second communication to conform to the second communication protocol, and (ii) sending the converted second communication via the third connection.

In a third respect, an example embodiment can take the form of a computer-readable storage medium having instructions stored thereon. The instructions, upon execution by a processor of a device, can cause the device to perform functions. The functions can include: (a) establishing at least first, second, and third connections, where the first and second connections utilize a first communication protocol and the third connection utilizes a second communication protocol, and where the first communication protocol differs from the second communication protocol, (b) receiving a first communication addressed to a first address via the first connection, (c) in response to receiving the first communication addressed to the first address, sending at least part of the first communication via the second connection, (d) receiving a second communication addressed to a second address via the first connection, where the first address differs from the second address, and (e) in response to receiving the second communication addressed to the second address: (i) converting the second communication to conform to the second communication protocol, and (ii) sending the converted second communication via the third connection.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings, wherein like numerals denote like entities, in which:

FIG. 1 is a block diagram of a system in accordance with an example embodiment;

FIG. 2A is a block diagram of an example access node;

FIG. 2B is a block diagram of an example scanner device;

FIGS. 3, 4, 5 and 6 illustrate various views and details of an example embodiment of the scanner device of FIG. 2B;

FIG. 7 illustrates an example address configuration between example devices;

FIG. 8 illustrates an example communication scenario using the example address configuration of FIG. 7;

FIG. 9 illustrates another example address configuration between example devices;

FIG. 10 illustrates an example communication scenario using the example address configuration of FIG. 9;

FIGS. 11A and 11B illustrate example user interfaces for an access node; and

FIG. 12 is a flow chart depicting functions that can be carried out in accordance with an example embodiment.

### DETAILED DESCRIPTION

### I. Introduction

This description sets forth systems comprising multiple devices. Each device of a described system is operable independently as well as in combination with other devices of the system. Each device of a described system can be referred to as an apparatus.

Each device of a described system is configured to carry out functions for servicing a device-under-service. The device-under-service can comprise a vehicle, a refrigeration unit, a personal computer, or some other serviceable device. Additionally or alternatively, the device-under-service can comprise a system such as a heating, ventilation, and air conditioning (HVAC) system, a security system, a computer system (e.g., a network), or some other serviceable system. The functions for servicing the device-under-service can include but are not limited to diagnostic functions, measurement functions, and scanning functions.

To work in combination with each other, the device of a described system is configured to communicate with another device via a communications network. The communications network can comprise a wireless network, a wired network, or both a wireless network and a wired network. Data obtained by a device from a device-under-service or data otherwise contained in that device can be transmitted to another device via the communications network between those devices.

Devices in the described system can be connected wired and/or wireless connections. Wired and wireless connections can utilize one or more communication protocols arranged according to one or more standards, such as an SAE International, International Organization for Standardization (ISO), or Institute of Electrical and Electronics Engineers (IEEE) 802 standard. The wired connection can be established using one or more wired communication protocols, such as the On-Board Diagnostic II (“OBD-II”) series of protocols (e.g., SAE J1850, SAE J2284, ISO 9141-2, ISO 12430, ISO 15765), IEEE 802.3 (“Ethernet”), or IEEE 802.5 (“Token Ring”). The wireless connection can be established using one or more wireless communication protocols, such as Bluetooth, IEEE 802.11 (“Wi-Fi”), or IEEE 802.16 (“WiMax”).

The devices on the communication network can include one or more “access nodes” or general-purpose computers (e.g., a laptop or desktop computer) equipped with software for controlling diagnostic equipment and/or the device-under-service. The access node can use general-purpose-communication protocols, such as, but not limited to Ethernet, Token Ring, Bluetooth, Wi-Fi, and WiMax to communicate with the diagnostic equipment and/or the device-under-service via use of a “scanner device” The scanner device can communicate with the access node using general-purpose-communication protocols and can communicate with the diagnostic equipment and/or the device-under-service using either general-purpose-communication protocols or using diagnostic-communication protocols, such as the OBD-II series of diagnostic-communication protocols. In some embodiments, the scanner device can use device-specific-communication protocols to communicate with diagnostic devices, such as a herein-described data-acquisition (DAQ) device.

The access node can address a packet or other protocol data unit to one or more addresses of the scanner device. In some embodiments, the scanner device processes the packet differently based on the address used by the access node. For example, the scanner device can provide two general-purpose-communication-protocol addresses for use by the access node. Packets addressed to a first address can use a general-purpose-communication protocol, while packets addressed to a second address can be converted from the general-purpose-communication protocol to a diagnostic-communication protocol. In particular of these embodiments, a third general-purpose-communication-protocol address can be used to direct conversion from the general-purpose-communication protocol to a device-specific-communication protocol. The scanner device can reverse these conversions for communications sent from the device-under-service and/or the diagnostic equipment to the access node.

As such, the access node can communicate with diagnostic equipment without being equipped with special-purpose diagnostic hardware (e.g., communication ports, cables, diagnostic boards). Rather, the access node can use a general-purpose-communication protocol to communicate with the scanner device, which can use one or more communication protocols to communicate with diagnostic equipment. Thus, relatively common and inexpensive general-propose computers equipped with general-purpose-communication interfaces can be used to investigate, diagnose, and repair devices-under-service. The relatively-low hardware costs and wide availability for access nodes in comparison to other types of diagnostic devices can reduce equipment costs for vehicle technicians. Communication software resident on the access node can be simplified, as the scanner device handles details of communication with diagnostic equipment and the device-under-service.

In combination, the access node and scanner device enable a vehicle technician to use a user interface of an access node to investigate, diagnose, and repair devices-under-service. In some embodiments, access nodes can be used to train vehicle technicians without having actual devices-under-service, perhaps using simulated or stored data viewed through the access-node user interface to investigate, diagnose, and repair simulated devices-under-service.

A tool salesman can sell one or more of the devices of a described system to a vehicle technician that works on devices-under-service. By selling devices that are operable as stand-alone devices as well as within a system of multiple devices, the tool salesman can sell the devices to a technician one at a time until the technician acquires one of each device operable within the system of multiple devices. This allows the vehicle technician to use the purchased device(s) on a device-under-service and to spread the cost of purchasing multiple devices over time without having to purchase the multiple devices all at once. Furthermore, the tool salesman can sell software applications (e.g., computer-readable program instructions) for execution on a device (e.g., an access node or a personal digital assistant) that the tool salesman does not sell, but that is operable with the a device of the descried systems to service a device-under-service.

### II. Example Architecture

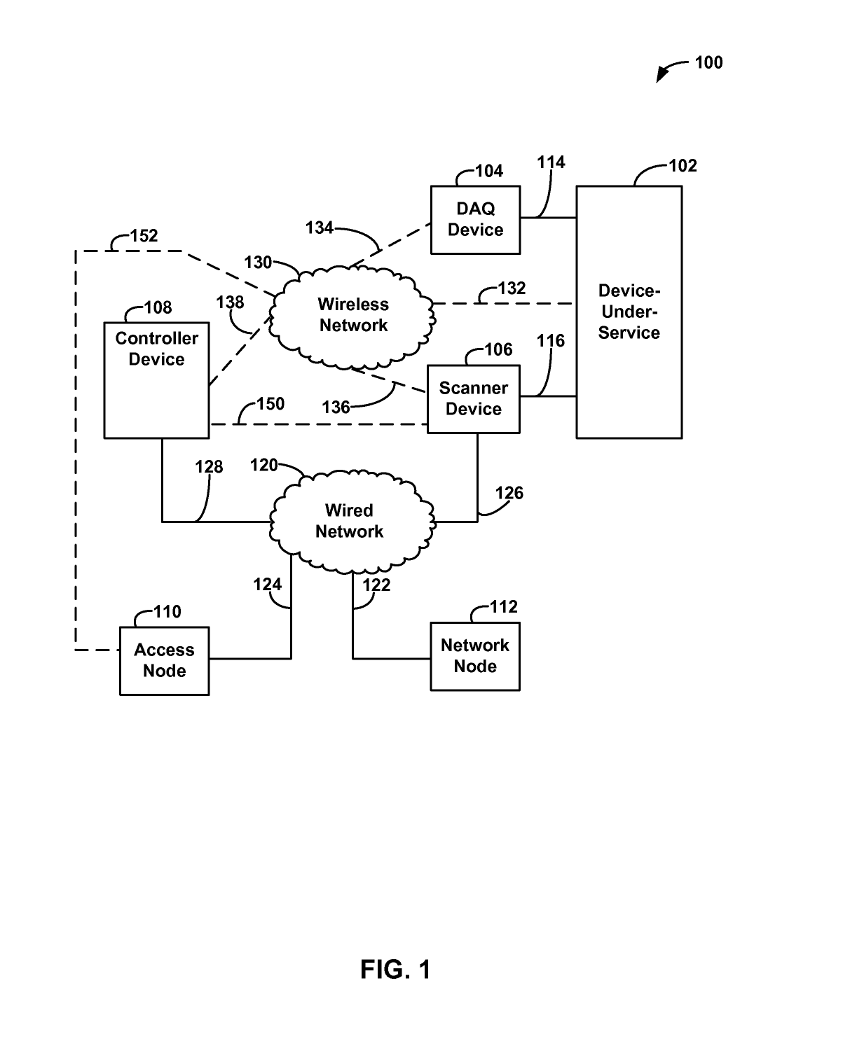

FIG. 1 is a block diagram of a system 100 in accordance with an example embodiment. The block diagram of FIG. 1 and other block diagrams and flow charts accompanying this description are provided merely as examples and are not intended to be limiting. Many of the elements illustrated in the figures and/or described herein are functional elements that can be implemented as discrete or distributed components or in conjunction with other components, and in any suitable combination and location. Those skilled in the art will appreciate that other arrangements and elements (for example, machines, interfaces, functions, orders, and groupings of functions, etc.) can be used instead. Furthermore, various functions described as being performed by one or more elements can be carried out by a processor executing computer-readable program instructions and/or by any combination of hardware, firmware, and software.

Devices shown in the Figures and described in this specification are also described in U.S. patent application Ser. No. 12/859,051, entitled “System and Method for Universal Scanner Module to Buffer and Bulk Send Vehicle Data Responsive to Network Conditions”, filed Aug. 18, 2010; U.S. Patent Application No. 61/374,805, entitled “Cable Assembly for Protection Against Undesired Signals,” filed Aug. 18, 2010; U.S. patent application Ser. No. 12/913,184, entitled “System and Method for Integrating Devices For Servicing a Device-Under-Service”, filed Oct. 27, 2010; and U.S. patent application Ser. No. 12/913,249, entitled “Method and Apparatus to Use Remote and Local Control Modes to Acquire and Visually Present Data”, filed Oct. 27, 2010, all of which are fully incorporated by reference herein for all purposes.

System 100 is configured to carry out a variety of functions, including functions for diagnosing, investigating, repairing, and servicing device-under-service 102. Device-under-service 102 can comprise a vehicle, such as an automobile, a motorcycle, a semi-tractor, farm machinery, or some other vehicle. The example embodiments can include or be utilized with any appropriate voltage or current source, such as a battery, an alternator, a fuel cell, and the like, providing any appropriate current and/or voltage, such as about 12 volts, about 42 volts, and the like. The example embodiments can be used with any desired system or engine. Those systems or engines can comprise items utilizing fossil fuels, such as gasoline, natural gas, propane, and the like, electricity, such as that generated by battery, magneto, fuel cell, solar cell and the like, wind and hybrids or combinations thereof. Those systems or engines can be incorporated into other systems, such as an automobile, a truck, a boat or ship, a motorcycle, a generator, an airplane and the like.

FIG. 1 shows system 100 includes devices 104, 106, and 108. For purposes of this description, device 104 is referred to as a data-acquisition (DAQ) device, device 106 is referred to as a scanner device or a remote device, and device 108 is referred to as a controller device. FIG. 1 shows wireless links using dashed lines and wired links using solid lines.

One or more of devices 104, 106, and 108 can connect to wired network 120. Wired network 120 can comprise one or more wired networks. Each of the one or more wired networks can be arranged to carry out communications according to a respective wired general-purpose-communication protocol, such as Ethernet, Token Ring, or some other wired general-purpose-communication protocol. For purposes of this description, a wired network arranged to carry out communications according to an IEEE 802.3 standard is referred to as an Ethernet network and a wired network arranged to carry out communications according to an IEEE 802.5 standard is referred to as a Token Ring network.

Scanner device 106 and controller device 108 can connect to wired network 120 via wired links 126 and 128, respectively. Wired network 120 can include and/or connect to the Internet, and wired network 120 can include and/or connect to one or more network nodes, such as an access node 110 and a network node 112. Access node 110 and network node 112 can connect to wired network 120 via wired links 124 and 122, respectively. Access node 110 can provide one or more of devices 104, 106, and 108 with wireless connectivity to wired network 120. Access node 110 and/or network node 112 can comprise a laptop or desktop personal computer (PC), a workstation that executes a Unix-based or Linux-based operating system, a server, and/or some other node that interfaces and/or connects to wired network 120. In accordance with an example in which device-under-service 102 comprises an automobile, access node 110 can comprise a laptop PC, desktop PC, or workstation operating at an automobile repair facility. In that regard, access node 110 and/or network node can operate as a server that provides software, commands, and data (e.g., automobile repair data, engine control unit or other software, DAQ commands, and/or instruction data) to device-under-service 102, DAQ device 104, scanner device 106, and/or controller device 108.

DAQ device 104 can connect to a device-under-service 102 via wired link 114. Wired link 114 can comprise one or more input leads. DAQ device 104 can comprise a digital volt meter (DVM), a digital volt ohm meter (DVOM), or some other type of measurement device. In some embodiments, DAQ device 104 can include a “remote mode” so that DAQ device 104 can be controlled via commands without physical contact with DAQ device 104.

Scanner device 106 can connect to device-under-service 102 via wired link 116. Wired link 116 can include one or more wired links for use with one or more diagnostic-communication protocols, such as the OBD-II series of protocols. Wired link 116 can be arranged as a cable assembly described in U.S. Patent Application No. 61/374,805, file Aug. 18, 2010, and is entitled “Cable Assembly for Protection Against Undesired Signals,” which is incorporated herein by reference. In other embodiments, wired link 116 can be arranged as some other wired link. Scanner device 106 can comprise a device configured to request and/or monitor data from one or more electronic control units (ECUs) of device-under-service 102, perhaps using the OBD-II series of protocols.

Wired link 116 can include one or more wired links for use with one or more general-purpose-communication protocols, such as Ethernet cables for use in an Ethernet network. Other example arrangements of wired link 116 are also possible.

Wireless network 130 can be established between any two or more of devices 104, 106, and 108. Wireless network 130 can comprise one or more wired networks. Each of the one or more wired networks can be arranged to carry out communications according to a respective wired general-purpose-communication protocol, such as Bluetooth, Wi-Fi, WiMAX, or some other wireless general-purpose-communication protocol. For purposes of this description, a wireless network arranged to carry out communications according to a Bluetooth standard is referred to as a Bluetooth network, a wireless network arranged to carry out communications according to an IEEE 802.11 standard is referred to as a Wi-Fi network, and a wireless network arranged to carry out communications according to an IEEE 802.16 standard is referred to as a WiMAX network.

Any of devices 104, 106, and 108 can join (e.g., begin communicating via) wireless network 130. As an example, FIG. 1 shows wireless network 130 connected to: DAQ device 104 via wireless link 134, scanner device 106 connected via wireless link 136, and controller device 108 via wireless link 138. In some embodiments, a wireless link includes a point-to-point wireless connection between two devices, such as wireless link 150 between scanner device 106 and controller device 108. Devices 104, 106, and 108 are configured to carry out communications with each other via wireless network 130. Other devices, such as a personal digital assistant (PDA), can be configured to join wireless network 130 as remote devices to communicate with other devices communicating via wireless network 130.

In some embodiments, device-under-service 102 can connect with wireless network 130 using wireless link 132. In other embodiments, access node 110 and/or network node 112 can connect to wireless network 130. FIG. 1 shows access node 110 connected to wireless network 130 using wireless link 152.

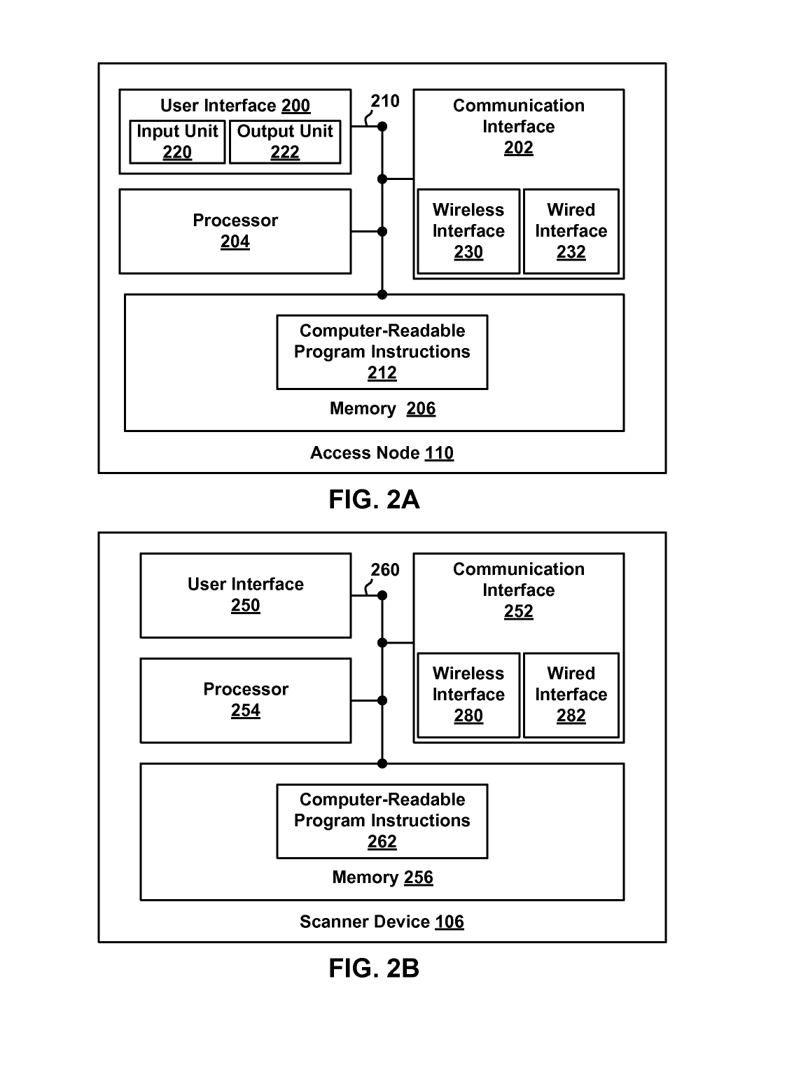

FIG. 2A is a block diagram of an example access node 110. As illustrated in FIG. 2A, access node 110 includes user interface 200, communication interface 202, processor 204, and memory 206, all of which can be linked together via a system bus, network, or other connection mechanism 210.

User interface 200 is configured to present data to and/or receive data from a user of access node 110. The user interface 200 can include input unit 220 and/or output unit 222. Input unit 220 can receive input, perhaps from a user of access node 110. Input unit 220 can comprise a keyboard, a keypad, a touch screen, a computer mouse, a track ball, a joystick, and/or other similar devices, now known or later developed, capable of receiving user input at access node 110.

Output unit 222 can provide output, perhaps to a user of access node 110. Output unit 222 can comprise a visible output device for generating visual output(s), such as one or more cathode ray tubes (CRT), liquid crystal displays (LCD), light emitting diodes (LEDs), displays using digital light processing (DLP) technology, printers, light bulbs, and/or other similar devices, now known or later developed, capable of displaying graphical, textual, and/or numerical information. Output unit 222 can alternately or additionally comprise one or more aural output devices for generating audible output(s), such as a speaker, speaker jack, audio output port, audio output device, earphones, and/or other similar devices, now known or later developed, capable of conveying sound and/or audible information.

Communication interface 202 can include wireless interface 230 and/or wired interface 232. Wireless interface 230 comprises one or more wireless transceivers configured to carry out communications via wireless network 130. Wireless interface 230 can comprise a Bluetooth transceiver, a Wi-Fi transceiver, or some other type of wireless transceiver. Wireless interface 230 can carry out communications with device-under-service 102, DAQ device 104, scanner device 106, controller device 108, or some other device that is operating to communicate via wireless network 130.

In accordance with an embodiment in which wireless interface 230 includes three or more wireless transceivers, two or more of the wireless transceivers can communicate according to a common air interface protocol or different air interface protocols.

Wired interface 232 can comprise one or more ports, such as Universal Serial Bus (USB) port(s) or Ethernet port(s). A USB port of wired interface 232 can communicatively connect to a first end of a USB cable. A second end of the USB cable can connect to a USB port of another device (e.g., device-under-service 102, DAQ device 104, scanner device 106, controller device 108, network node 112.) Similarly, an Ethernet port of wired interface 232 can communicatively connect to a first end of an Ethernet cable, while a second end of the Ethernet cable can connect to a respective Ethernet port of a device connected to wired network 120 or some other device.

Processor 204 can comprise one or more general purpose processors (e.g., INTEL and/or Advanced Micro Devices microprocessors) and/or one or more special purpose processors (e.g., digital signal processors). Processor 204 can execute computer-readable program instructions 212 stored in memory 206.

Memory 206 can comprise a computer-readable storage medium readable by processor 204. The computer-readable storage medium can comprise volatile and/or non-volatile storage components, such as optical, magnetic, organic or other memory or disc storage, which can be integrated in whole or in part with processor 204. Memory 206 can store computer-readable program instructions 212, as well as data used by computer-readable program instructions 212, other computer-readable program instructions, and/or other data. Computer-readable program instructions 212 can include instructions that, in response to execution by processor 204, cause access node 110 to perform at least the herein-described functions of access node 110.

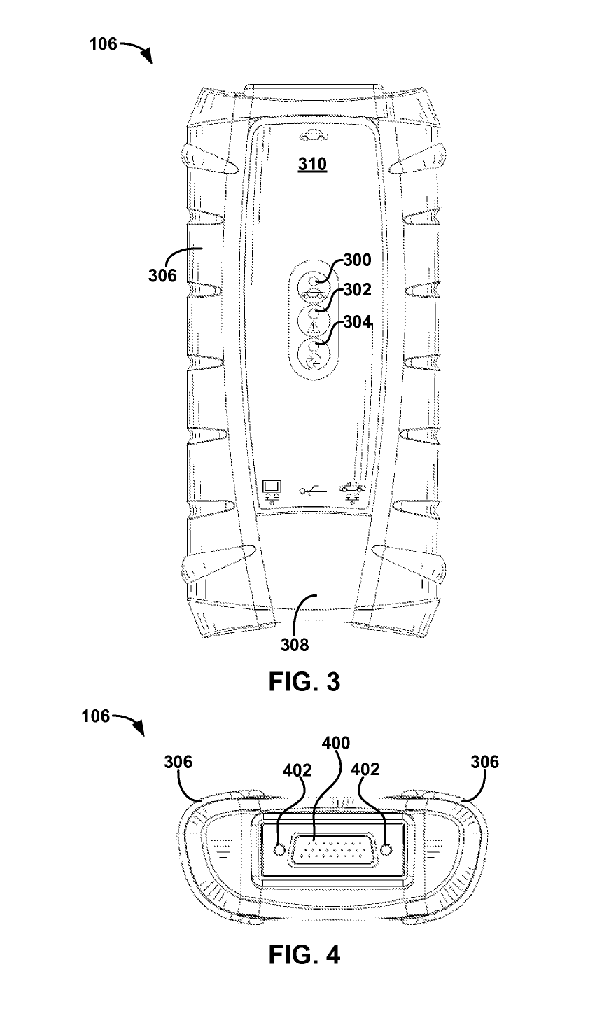

FIG. 2B is a block diagram of an example scanner device 106 and FIGS. 3-6 illustrate details of an example embodiment of scanner device 106. As illustrated in FIG. 2B, scanner device 106 includes user interface 250, communication interface 252, processor 254, and memory 256, all of which can be linked together via a system bus, network, or other connection mechanism 260.

User interface 250 is configured to present data to a user of scanner device 106. Elements of user interface 250 are illustrated in FIG. 3.

Communication interface 252 can include wireless interface 280 and/or wired interface 282. Wireless interface 280 comprises one or more wireless transceivers configured to carry out communications via wireless network 130. Wireless interface 280 can comprise a Bluetooth transceiver, a Wi-Fi transceiver, or some other type of wireless transceiver. Wireless interface 280 can carry out communications with device-under-service 102, DAQ device 104, scanner device 106, controller device 108, or some other device that is operating to communicate via wireless network 130.

For example, wireless interface 280 can comprise a Bluetooth transceiver and a Wi-Fi transceiver. In accordance with such an example, the Wi-Fi transceiver can establish wireless link 136 to communicate with device-under-service 102, DAQ device 104, controller device 108, and/or access node 110 via a Wi-Fi network of wireless network 130, and the Bluetooth transceiver can establish wireless link 132 to communicate with device-under-service 102 via a Bluetooth network of wireless network 130.

In accordance with an embodiment in which DAQ device 104, scanner device 106 and controller device 108 each include at least a Bluetooth transceiver, one of the devices, such as controller device 108, can operate as a master, and the other devices, such as DAQ device 104 and scanner device 106, can operate as slaves to the master.

In accordance with an embodiment in which wireless interface 280 includes three or more wireless transceivers, two or more of the wireless transceivers can communicate according to a common air interface protocol or different air interface protocols.

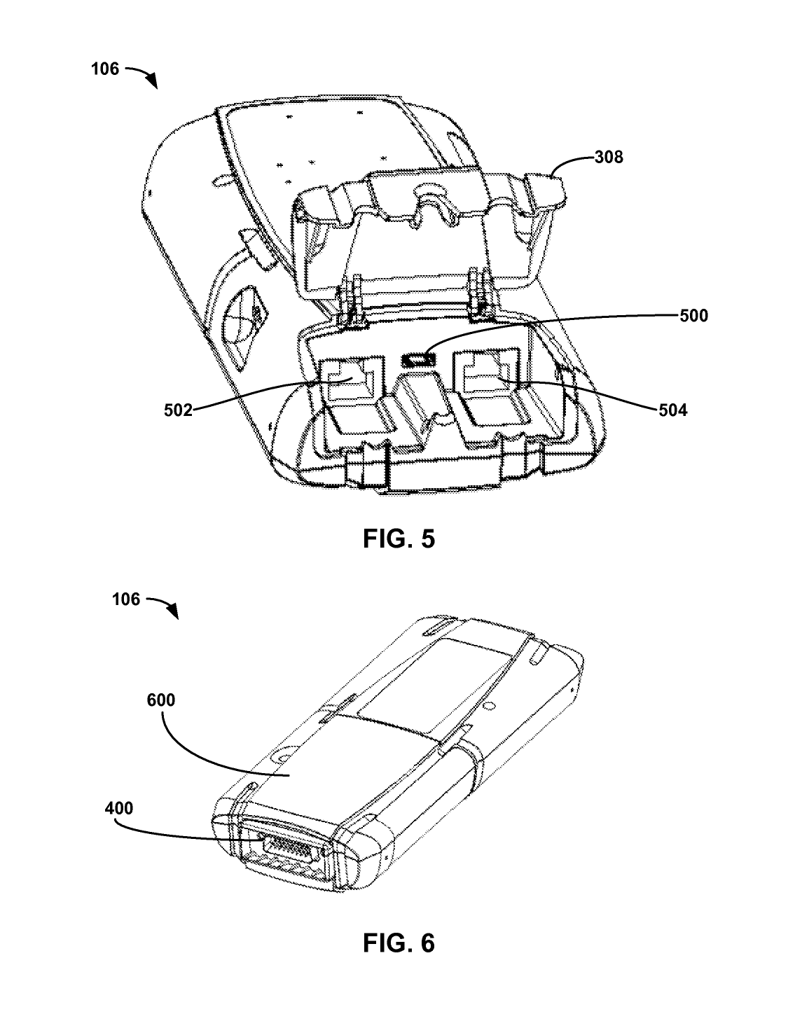

Wired interface 282 may comprise one or more ports. As an example, wired interface 206 may include ports 500, 502, and 504 (illustrated in FIG. 5).

Port 500 may comprise a USB port that communicatively connects to a first end of a USB cable. A second end of the USB cable may connect to some other device (e.g., device-under-service 102, DAQ device 104, controller device 108, access node 110, or network node 112.)

Ports 502 and 504 may comprise respective Ethernet ports. Each Ethernet port may communicatively connect to a first end of a respective Ethernet cable. A second end of each Ethernet cable may connect to a respective Ethernet port connected to a device connected to wired network 120 or some other device. As an example, port 502 may connect to an Ethernet port of network node 112.

Processor 254 can comprise one or more general purpose processors (e.g., INTEL and/or Advanced Micro Devices microprocessors) and/or one or more special purpose processors (e.g., digital signal processors). Processor 254 can execute computer-readable program instructions 262 that are stored in memory 256.

Memory 256 can comprise a computer-readable storage medium readable by processor 254. The computer-readable storage medium can comprise volatile and/or non-volatile storage components, such as optical, magnetic, organic or other memory or disc storage, which can be integrated in whole or in part with processor 254. Memory 256 can include computer-readable program instructions 262, as well as data used by computer-readable program instructions 262, other computer-readable program instructions, and/or other data. Computer-readable program instructions 262 can include instructions that, in response to execution by processor 254, cause scanner device 106 to perform at least the herein-described functions of scanner device 106.

Next, FIG. 3 illustrates a front view of an example embodiment of scanner device 106. FIG. 3 further illustrates that scanner device 106 includes visual indicators 300, 302, and 304, a grip 306, a port access cover 308, and a cover 310. Port access cover 308 can provide protection for one or more ports of wired interface 282. Cover 310 can provide protection for user interface 250, processor 254, memory 256, wireless interface 280, and wired interface 282.

Visual indicators 300, 302, and 304, which can be part of user interface 250, can include a respective light emitting diode (LED) or some other visual indictor that is configured to convey information to a user. Computer-readable program instructions 262 can be executable by processor 254 to turn visual indicators 302, 304, and 306 on and off.

Visual indicator 300 can turn off to indicate that scanner device 106 is both not communicating with and not receiving electrical power from device-under-service 102. Visual indicator 300 can turn on to indicate that remote device 106 is receiving electrical power from device-under-service 102 but is not communicating with device-under-service 102. Visual indicator 300 can flash (e.g., turn on for 1 second and then turn off for 1 second) to indicate scanner device 106 is both communicating with and receiving electrical power from device-under-service 102.

Visual indicator 302 can turn on and off to so as to flash. In particular, visual indicator 302 can flash in specific sequences so as to identify any of a variety of diagnostic codes. The diagnostic codes, for example, could pertain to (i) device-under-service 102, (ii) scanner device 106, or (iii) a device that is configured to communicate with scanner device 106 via wireless interface 280. As an example, visual indicator 302 can flash 3 times, wait, and then flash 2 more times, so as to visually present a diagnostic code of 32. Also, visual indicator 302 can turn off to indicate no error (and hence no diagnostic code) has been found, and can turn on to indicate a failure within scanner device 106.

Visual indicator 304 can turn off to indicate scanner device 106 is not communicating with controller device 108. Visual indicator 304 can turn on to indicate that scanner device 106 is carrying out wired communications with controller device 108 and can flash to indicate that scanner device 106 is carrying out wireless communications with controller device 108.

Other examples of presenting data via visual indicators 300, 302, 304 are also possible.

Grip 306 can be arranged to cover portions of port access cover 308 and portions of cover 310. Grip 306 can be removed away from port access cover 308 so as to allow port access cover 308 to be moved to an open position. Grip 306 can be made from rubber. As an example, grip 306 can be arranged as a single piece of rubber. When attached to scanner device 106, grip 306 can provide shock protection to scanner device 106 in the event that scanner device 106 is dropped or struck.

Next, FIG. 4 illustrates a top view of an example embodiment of scanner device 106. FIG. 4 further illustrates grip 306 and that scanner device 106 includes a port 400 and connector mounting holes 402. As an example, port 400 can include a high-density-26 (HD-26) connector, but is not so limited. An HD-26 connector can include 26 male or female connector terminals. Port 400 is arranged to connect to wired link 116. Wired link 116 can include fasteners that are arranged to fasten wired link 116 to scanner device 106 via connector mounting holes 402. In some embodiments, port 400 can be used with a suitable cable for communications in accordance with an OBD-II protocol.

Next, FIG. 5 illustrates an example embodiment of scanner device 106, but without grip 306. FIG. 5 further illustrates port access cover 308 in an open position and that scanner device 106 includes ports 500, 502, and 504.

Port 500 can be arranged as a USB port or some other type of wired port, and ports 502 and 504 can be arranged as Ethernet ports or some other type of wired ports. In an alternative embodiment, the ports accessible via port access cover 308 can include a quantity of ports less than 3 ports or greater than 3 ports. Scanner device 106 can include a respective cable opening for each port accessible via port access cover 308. Alternatively, one or more cable openings can allow multiple cables to pass through port access cover 308 so as to extend away from scanner device 106.

Next, FIG. 6 illustrates an example embodiment of scanner device 106, but without grip 306. FIG. 6 further illustrates expansion cover 600 and port 400. Expansion cover 600 is removable from scanner device 106 so as to provide access to an expansion port.

### III. Example Communications

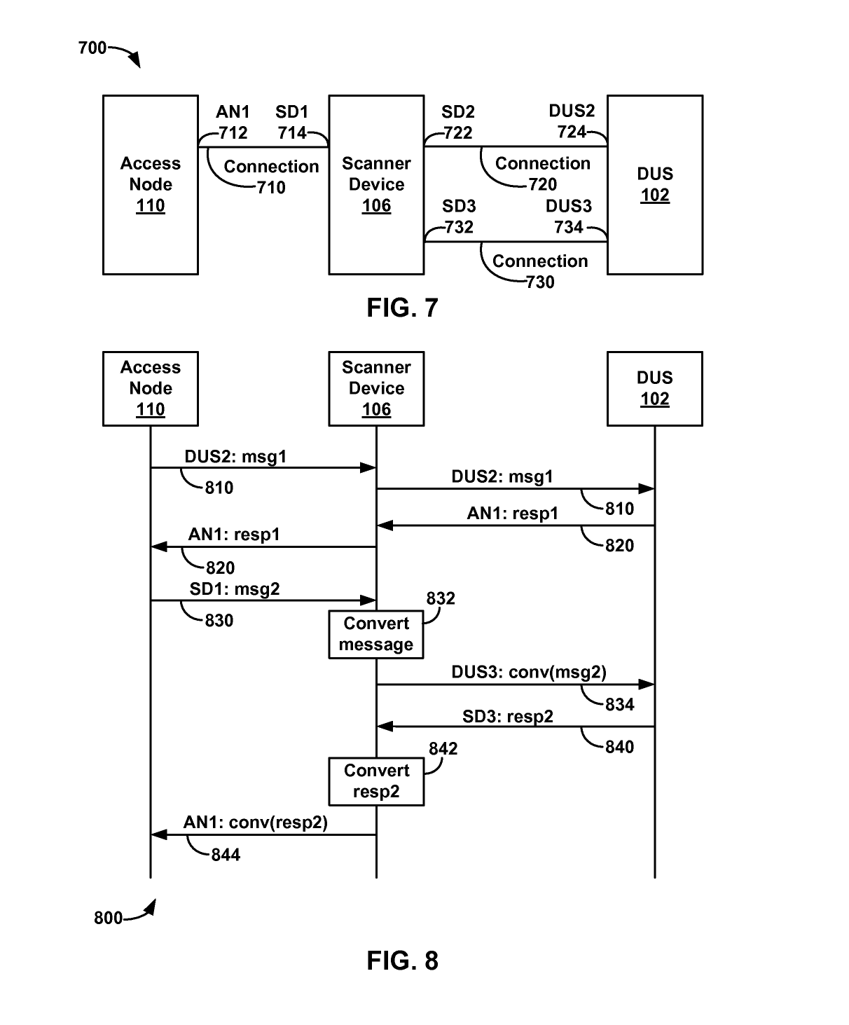

FIG. 7 illustrates an example address configuration 700 between access node (AN) 110, scanner device (SD) 106, and device-under-service (DUS) 102. FIG. 7 shows access node 110 and scanner device 106 communicatively coupled via connection 710, and scanner device 106 and device-under-service 102 communicatively coupled via connections 720 and 730. In some embodiments, communications over connections 710 and 720 both use a first communication protocol and connection 730 uses a second communication protocol. For example, connections 710 and 720 can use an Ethernet protocol and connection 730 can use an OBD-II protocol. As another example, connections 710 and 720 can use a Wi-Fi protocol and connection 730 can use an OBD-II protocol.

Each of access node 110, scanner device 106, and device-under-service 102 can be assigned one or more addresses to identify a device and/or connection. In some embodiments, an address includes one or more bits utilized by a communication protocol to identify a particular device, such as an Ethernet address (e.g., a six-byte address such as 12:34:56:78:9a:bc) or an Internet Protocol address (e.g., a four-byte IPv4 address such as 192.255.0.1, a sixteen-byte IPv6 address such as 2001:ab10:85a3:8e2f:4:3:0:80f2). In other embodiments, an address identifies one or more communication ports of a device (e.g., port 402 of scanner device 106). Other types of addresses are possible as well.

Connections 710, 720, and 730 can be established in accordance with procedures specified by a corresponding communication protocol. For example, the Ethernet protocol specifies types of physical connections (e.g., coaxial cable, twisted pair cable, CATS cable, RJ-45 cables, fiber optic cable) as well as minimum and maximum distances of physical connections. In some embodiments, an Ethernet physical connection can be established by connecting a first end of an Ethernet cable with either port 502 or 504 of scanner device 106 and by connecting a second end of the Ethernet cable with an Ethernet port of device-under-service 102 or access node 110.

Once an Ethernet physical connection is established, access to an Ethernet connection or “bus” is established by use of a carrier sense access method, such as Carrier Sense Multiple Access with Collision Detection (CSMA/CD). CSMA/CD includes first “sensing” or detecting that another device is transmitting on the Ethernet connection, and if no device is sensed, transmitting a first bit of an Ethernet packet or “frame.” If a collision is detected for the first bit, a collision recovery algorithm is used to attempt retransmission. If a collision is not detected for the first bit, the remainder of the Ethernet frame is transmitted on the Ethernet connection.

An Ethernet frame can include a header, a data field, and a checksum. The header of the Ethernet frame can include a source Ethernet address, a destination Ethernet address, and a type of connection used. The data field can include user data, such as a payload portion of a message, discussed below in more detail in the context of at least FIGS. 8 and 10. The checksum can be a result of a calculation performed on the header and/or data field that can be used to verify correctness of the header and/or data field after transmission.

As another connection-establishment example, an OBD-II physical connection for use by the OBD-II series of protocols can be established using a cable with two or more diagnostic connectors, such as the cable assembly discussed above in more detail in the context of FIG. 1. In some embodiments, a first connector of the cable assembly is connected to port 400 of scanner device 106 and a second connector of the cable assembly is connected to an OBD-II port of device-under-service 102.

Once the OBD-II physical connection is established, the OBD-II series of protocols can transmit OBD-II messages over the OBD-II physical connection using an OBD-II message format. An OBD-II message format can include: start-of-frame and end-of-frame data, a message identifier, an identifier related to remote messaging, an acknowledgment flag, cyclic redundancy check data, and OBD-II payload data. The OBD-II payload data can include a control field indicating a number of bytes in an OBD-II payload field, and the OBD-II payload field. The OBD-II payload field can specify an OBD-II mode, an OBD-II parameter ID (PID), and additional payload data. Example OBD-II modes include, but are not limited to, modes to: show current data, show freeze frame data, show stored Diagnostic Trouble Codes (DTCs), clear DTCs and stored values, test results for oxygen sensor monitoring, test results for other components, show DTCs detected during current or last driving cycle, control operation of on-board component/system, request vehicle information mode, and a permanent/cleared DTC mode. Example OBD-II PIDs include, but are not limited to, freeze DTC, fuel system status, engine coolant temperature, fuel trim, fuel pressure, engine revolutions/minute (RPMs), vehicle speed, timing advance, and intake air temperature. Many other OBD-II modes and OBD-II PIDs are possible as well.

FIG. 7 shows access node 110 assigned address AN1 712 and scanner device 106 assigned address SD1 714 for use with connection 710. Scanner device 106 is assigned address SD2 722 and device-under-service 102 is assigned address DUS2 724 for use with connection 720. Scanner device 106 is assigned address SD3 732 and device-under-service 102 is assigned address DUS3 734 for use with connection 730.

Scanner device 106, access node 110, and/or device-under-service 102 can direct communications between each other based on destination addressing. In some of these embodiments, directing communications can implicitly request protocol conversion; that is, if connection 710 utilizes a different communication protocol than connection 720 or connection 730, scanner device 106 can convert at least part of a payload portion of a message received via connection 710 to the different communication protocol.

In an example embodiment, access node 110 can direct a message to connection 720 by addressing a message to scanner device 106 with a destination address of DUS2, and access node 110 can direct a message to connection 730 by addressing a message to scanner device 106 with a destination address of SD1. In this example, connections 710 and 720 can use an Ethernet protocol and connection 730 can use an OBD-II protocol. Then, a message sent from access node 110 to scanner device 106 addressed to address SD1 can implicitly request protocol conversion from an Ethernet protocol used by connection 710 to an OBD-II protocol used by connection 730.

However, a message sent from access node 110 to scanner device 106 addressed to address SD1 may not implicitly request protocol conversion. For example, the protocol can include an “address-to” function that determines an ultimate destination, e.g., scanner device 106 or device-under-service 102, and if the message is addressed to address SD1 with an address-to of scanner device 106, then the message will not be protocol converted, but if the address-to equals a device other scanner device 106, a protocol conversion will be requested.

As another example, the protocol can include an explicit “convert message” flag and/or a data item specifying a destination protocol. As yet another example, scanner device 106 can examine a “message code” in the message and determine the ultimate destination and/or protocol conversion based on the message code. For example, a message code of “get scanner data” would have an ultimate destination of scanner device 106 without conversion, while a message code of “get OBD data” would have an ultimate destination of device-under-service 102 and would request a protocol conversion to an OBD protocol. Many other examples are possible as well.

Once any necessary protocol conversion has taken place, scanner device 106 can send a corresponding message to device-under-service 102. Similarly, scanner device 106 can perform protocol conversions for messages sent from device-under-service 102 to access node 110 as needed, such as described below in more detail in the context of at least FIGS. 8 and 10.

As such, scanner device 106 can present a single-protocol communication interface to access node 110, while performing any necessary protocol conversions needed. In the other direction, scanner device 106 can communicate with device-under-service 102 using general-purpose-communication protocols, device-specific-communication protocols, and/or diagnostic-communication protocols as directed by access node 110.

FIG. 8 illustrates an example communication scenario 800 using example address configuration 700 described above in the context of FIG. 7. Addresses in address configuration 700 can identify a device, connection, and/or communication protocol in communications between access node 110, scanner device 106, and device-under-service 102.

Scenario 800 involves communication of messages sent from a “source device” with a “source address” to a “destination device” with a “destination address.” Messages sent in scenario 800 include at least two portions: an “address portion” and a “payload portion.” The address portion includes a destination address and perhaps a source address (not shown in FIG. 8). The payload portion includes user data destined for a device associated with the destination address.

FIG. 8 shows address portions and payload portions of messages separated by a “:”. For example, FIG. 8 shows message 810 sent from access node 110 (i.e., the source device) to destination address “DUS2” of scanner device 106 (i.e., the destination device) with a payload portion of “msg1.”

In scenario 800, connections 710 and 720 use a common protocol and connection 730 uses a different protocol from the common protocol. In some embodiments, the common protocol is an Ethernet protocol and the different protocol is an OBD-II protocol.

Scenario 800 begins with message 810 being sent from access node 110 addressed to address SD1a of scanner device 106. Upon reception of message 810 via connection 710, scanner device 106 examines destination address DUS2 and determines that message 810 is destined for device-under-service 102 via connection 720.

In some embodiments, scanner device 106 can store data used to direct or otherwise aid routing of messages, perhaps stored in a data structure such as a “routing table” or similar data structure. The routing table can include a mapping of input address and/or input connection to output address and/or output connection. As such, scanning device 106 can perform searches of the routing table to map and then use entries retrieved by the searches to route input addresses/connections to output addresses/connections.

Table 1 below shows an example routing table for scanner device 106 based on example address configuration 700:

TABLE 1

| Input Connection | Input Address | Output Connection | Output Address |
|---|---|---|---|
| 710 | DUS2 | 720 | DUS2 |
| 710 | SD1b | 730 | DUS3 |
| 720 | SD2 | 710 | AN1 |
| 730 | SD3 | 710 | AN1 |

In some embodiments, scanner device 106 can store data in a “protocol table” or similar data structure related to protocol conversions. In some embodiments, the protocol table can store data to indicate a protocol used on each connection utilized by scanner device 106. For example, let connections 710 and 720 use an Ethernet protocol and connection 730 uses an OBD-II protocol. Table 2 below shows a corresponding example protocol table:

TABLE 2

| Connection | Protocol |
|---|---|
| 710 | Ethernet |
| 720 | Ethernet |
| 730 | OBD-II |

In other embodiments, different encodings can be used for connections and/or protocols in a protocol table. In some embodiments, some of the data stored in the routing table can include data related protocol conversions (i.e., the routing table can include the protocol table). In example Table 2 above, both connections 710 and 720 use a common “Ethernet” protocol while connection 730 uses a different “OBD-II” protocol.

As both connections 710 and 720 use the common protocol, scanner device 106 can route message 810 to device-under-service 102 without protocol conversion, perhaps using a routing table, such as example Table 1 above, and/or a protocol table, such as example Table 2 above. In some embodiments, such as shown in FIG. 8, scanner device 106 can pass through message 810 from access node 110 to device-under-service 102 without changing the message.

In other embodiments not shown in FIG. 8, scanner device 106 can change message 810 during routing. For example, scanner device 106 can route message 810 by changing a destination address and/or a source address of message 810 without otherwise changing the payload portion of message 810. In these embodiments, changed message 810 can then be sent to a destination.

Scenario 800 continues with device-under-service 102 sending message 820 in response to message 812. Message 820 is addressed to access node 110 at address AN1 and is sent via connection 720. In some embodiments, such as shown in FIG. 8, scanner device 106 can pass through message 820 from device-under-service 102 to access node 110 without changing the message.

In other embodiments not shown in FIG. 8, scanner device 106 can change message 820 during routing. For example, upon reception of message 820 via connection 720, scanner device 106 determines that message 820 is destined for access node 110 via connection 710, and that the destination address is to be changed, perhaps using the above-mentioned routing table. Then, to route message 820, scanner device 106 can change message 820 by changing at least a destination address of message 820 and send message 820.

Scenario 800 continues with message 830 being sent from access node 810 addressed to address SD1 of scanner device 106. Upon reception of message 830 via connection 710, scanner device 106 examines destination address SD1 and, perhaps using the above-mentioned routing table, determines that message 830 is destined for device-under-service 102 via connection 730.

As mentioned above, during scenario 800, connections 710 and 720 use a common protocol and connection 730 uses a different protocol from the common protocol. Perhaps using the above-mentioned protocol table, scanner device 106 can determine an input protocol used on the input connection for message 830 (connection 710) is “Ethernet” and an output protocol used on the corresponding output connection (connection 730) is “OBD-II”. As the input protocol is not the same as the output protocol, scanner device 106 can determine that a protocol conversion of at least a payload portion of a message from the input protocol to the output protocol is required.

In some embodiments, the use of different protocols may not require protocol conversion of a payload portion. As one example, some embodiments may use different but compatible protocols that do not require payload-portion conversion. As another example, some embodiments can use connections with different physical and/or data-link layer protocols (e.g., connections using a combination of Ethernet, Wi-Fi and/or WiMAX protocols) while conforming to a common network and/or transport layer communication protocol (e.g., a TCP/IP protocol). As the higher-level network and/or transport layer communication protocol is common between connections, payload-portion conversions may not be required.

At block 832 of scenario 800, scanner device 106 converts at least a payload portion of message 830 from the input protocol to the output protocol.

For example, if the input protocol is an Ethernet protocol and the output protocol is an OBD-II protocol, scanner device 106 can extract the data from message 830 with a payload portion (e.g., a data field of an Ethernet frame carrying message 830) containing “msg2.” In some embodiments, scanner device 106 can verify that “msg2” is configured for use with an OBD-II protocol, perhaps by verifying at least OBD-II mode and/or an OBD-II PID. In some embodiments, “msg2” can include at least an OBD-II mode and an OBD-II PID in American Standard Code for Information Interchange (ASCII) format. Then, scanner device 106 can generate an OBD-II message including OBD-II payload data with: (a) a number of bytes in “msg2” as a control field and (b) the contents of “msg2” as an OBD-II payload field.

To route message 830, scanner device 106 can generate message 834 by changing a destination address of message 830 and use the converted payload portion of message 830 as the payload portion of message 830. In some embodiments, the conversion of block 832 includes generation of an entire message (e.g., message 834), and thus changing the destination address is not required. The converted payload portion of message 830 is shown in FIG. 8 is indicated as a “conv(msg2)” payload portion of message 834 The nomenclature “conv(X)” indicates the converted portion of payload X; as shown in message 834 of FIG. 8, “conv(msg2)” is a converted portion of payload “msg2”, which FIG. 8 indicates is the payload portion of message 830.

Once message 834 has been generated, scanner device 106 can send message 834 to device-under-service 102 at address DUS2 via connection 730.

Scenario 800 continues with device-under-service 102 sending message 840 in response to message 834. Message 840 is addressed to scanner device 106 at destination address SD3 and is sent via connection 730.

Upon reception of message 840 via connection 730, scanner device 106 determines that message 840 is destined for access node 110 via connection 710, perhaps using the above-mentioned routing table. Also, scanner device 106 determines that a protocol conversion is required to send message 840 to access node 110 via connection 730, perhaps using the above-mentioned protocol table.

At block 842 of scenario 800, scanner device 106 converts at least a payload portion of message 840 from the input protocol (i.e. the different protocol of connection 730) to the output protocol (i.e., the common protocol of connection 710).

For example, if the input protocol is an OBD-II protocol and the output protocol is an Ethernet protocol, scanner device 106 can extract the data from message 840 with a payload portion (e.g., an OBD-II message payload field of an OBD-II message 840) containing “resp2.” Then, scanner device 106 can generate an Ethernet frame with a data field including the contents of “resp2.”

To route message 840, scanner device 106 can generate message 844 by changing a destination address of message 840 to address AN1 of access node 110 and including a converted payload portion of message 840 (shown in FIG. 8 as “conv(resp2)” of message 844) as the payload portion of message 844. In some embodiments, the conversion of block 842 includes generation of an entire message (e.g., message 844), and thus changing the destination address is not required.

Once message 844 has been generated, scanner device 106 can send message 844 to access node 110 via connection 710.

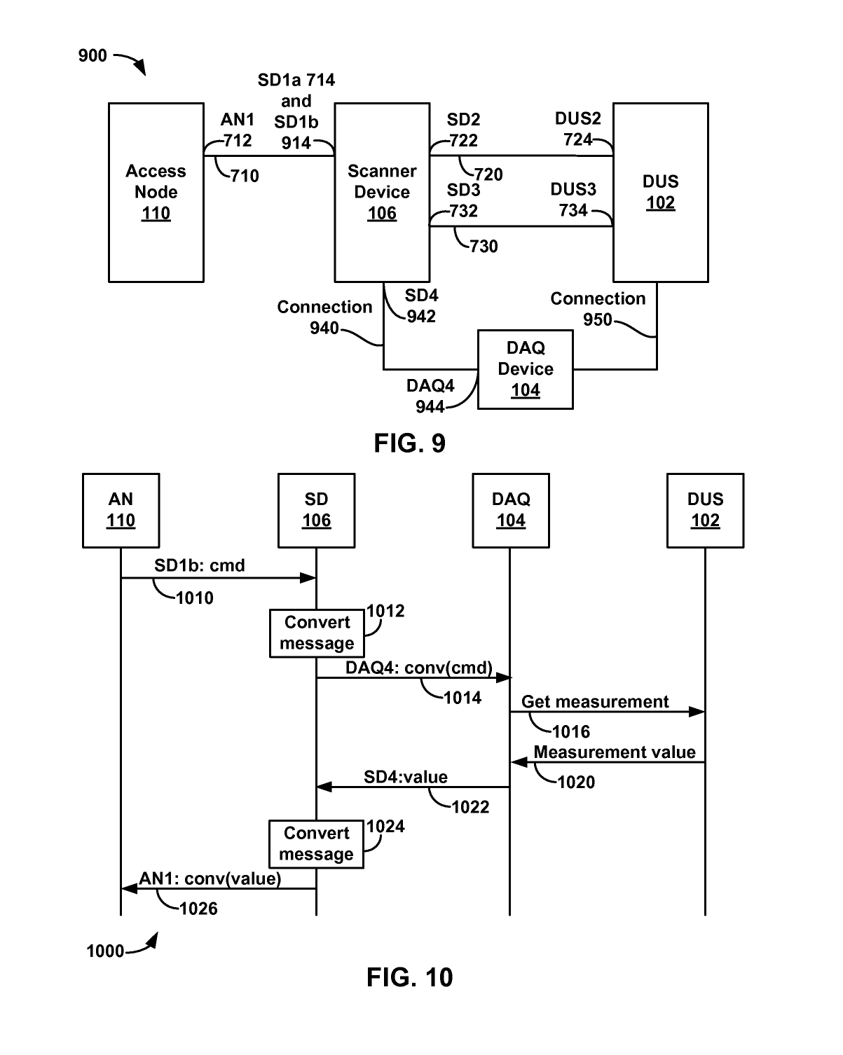

FIG. 9 illustrates another example address configuration 900 between example devices. As with FIG. 7, FIG. 9 shows access node 110 assigned address AN1 712, scanner device 106 assigned addresses SD1a 714, SD2 722, SD3 732, and SD1b 914, and device-under-service 102 assigned address DUS2 724 and DUS3 734.

FIG. 9 also shows DAQ device 104 connected to scanner device 106 via connection 940 and connected to DUS 102 via connection 950. FIG. 9 shows scanner device 106 equipped with a second address, SD1b 914, for connection 710, and an address SD4 942 for connection 940. FIG. 9 depicts DAQ device 104 with address DAQ4 944 for connection 940. Connection 950 is shown without specific addresses. In some embodiments, DAQ device 104 and device-under-service 102 are connected via one or more input leads as discussed above in the context of FIG. 1. As input leads typically do not use addresses, no addresses are shown in FIG. 9 on connection 950. In other embodiments not shown in FIG. 9, DAQ device 104 and/or device-under-service 102 are assigned addressees for use with connection 950.

In some embodiments not shown in FIG. 9, DAQ device 104 connects with a device other than scanner device 106, such as controller device 108. In other embodiments, DAQ device 104 connects to scanner device 106 and/or controller device 108 using a wired or wireless general-purpose-communication protocol, such as but not limited to, Ethernet, Token Ring, Bluetooth, Wi-Fi, and WiMAX.

As with address configuration 700, access node 110 can direct a message to use connection 720 between by addressing a message to device-under-service 102 with a destination address of DUS2 724, and access node 110 can direct a message to use connection 730 by addressing a message to scanner device 106 with a destination address of SD1a 714. In address configuration 900, access node 110 also can direct commands or other types of messages for delivery to DAQ device 104 by sending a message to scanner device 106 via connection 710 addressed to address SD1b 914.

Connections 940 and 950 can be established in accordance with procedures specified by a corresponding communication protocol. For example, connection 940 can utilize a wireless protocol to provide a physical connection, such as Bluetooth, Wi-Fi, or WiMAX. In other embodiments, connection 940 can be established using the Ethernet connection procedures described above in more detail in the context of FIG. 7. Once the physical connection for connection 940 is established, DAQ device 104 is ready to communicate with scanner device 106.

As another example, connection 950 can include input leads as mentioned above. An input lead can be connected to DAQ device 104 at an input jack of DAQ device 104 and can be connected to device-under-service 102 as needed by a technician servicing device-under-service 102.

FIG. 10 illustrates an example communication scenario 1000 using example address configuration 900 described above in the context of FIG. 9. In scenario 1000, connections 710 and 720 use a common protocol, connection 730 uses a different protocol from the common protocol, and connection 940 uses a device-specific protocol. In some embodiments, the common protocol is an Ethernet protocol, the different protocol is an OBD-II protocol, and the device-specific protocol is a DAQ protocol.

Table 3 below shows an example routing table for scanner device 106 based on example address configuration 900:

TABLE 3

| Input Connection | Input Address | Output Connection | Output Address |
|---|---|---|---|
| 710 | DUS2 | 720 | DUS2 |
| 710 | SD1a | 730 | DUS3 |
| 710 | SD1b | 940 | DAQ4 |
| 720 | SD2 | 710 | AN1 |
| 730 | SD3 | 710 | AN1 |
| 940 | SD4 | 710 | AN1 |

In this example, connections 710 and 720 use an Ethernet protocol, connection 730 use an OBD-II protocol, and connection 940 use a DAQ protocol. Table 4 below shows a corresponding example protocol table:

TABLE 4

| Connection | Protocol |
|---|---|
| 710 | Ethernet |
| 720 | Ethernet |
| 730 | OBD-II |
| 940 | DAQ |

Scenario 1000 begins with message 1010 being sent from access node 110 addressed to address SD1b of scanner device 106. Upon reception of message 1010 via connection 710, scanner device 106 examines destination address SD1b and determines that message 1010 is destined for DAQ device 104 via connection 940, perhaps using a routing table such as shown in example Table 3 above. Scanner device 1010 compares protocols used on input connection 710 and output connection 940 and determines a protocol conversion is required, perhaps using a protocol table such as shown in example Table 4 above.

At block 1012, scanner device 106 converts at least a payload portion of message 1012 from the input protocol to the output protocol. To route message 1010, scanner device 106 can generate message 1014 by changing a destination address of message 1010 and including the converted payload portion of message 1010 as the payload portion of message 1014. The converted payload portion of message 1010 is shown in FIG. 10 is indicated as a “conv(cmd)” payload portion of message 1014.

Once message 1014 has been generated, scanner device 106 can send message 1014 to DAQ device 104 at address DAQ4 via connection 940.

DAQ device 104 processes the payload portion of message 1014 to determine a measurement of device-under-service is requested. DAQ device 104 then takes the requested measurement via connection 950 of device-under-service 102, as shown as message 1016 of FIG. 10. In some embodiments, the requested measurement can be in the form of a reading of a physical characteristic (e.g., voltage or current), and thus no specific message or message format would be used for message 1016 and/or message 1020.

Message 1020 of FIG. 10 represents a value of the requested measurement taken by message 1016. For example, the requested measurement could be a voltage, current, or resistance measurement, and the value could then be a voltage, current, or resistance value, respectively. Many other types of measurements and corresponding values are possible as well.

Upon reception of measurement value 1020, DAQ device 104 generates message 1022 with a destination address of SD4 of scanning device 106 and a payload portion including a representation of measurement value 1020 (e.g., binary data and/or alphanumeric characters indicating the measurement value.) Once message 1022 is generated, DAQ device 104 sends message 1022 to scanner device 106 via connection 940.

Upon reception of message 1022 via connection 940, scanner device 106 determines that message 1022 is destined for access node 110 via connection 710, perhaps using the above-mentioned routing table. Also, scanner device 106 determines that a protocol conversion is required to send message 1022 to access node 110 via connection 710, perhaps using the above-mentioned protocol table.

At block 1024 of scenario 1000, scanner device 106 converts at least a payload portion of message 1024 from the input protocol (i.e. the device-specific protocol of connection 940) to the output protocol (i.e., the common protocol of connection 710).

To route message 1022, scanner device 106 can generate message 1022 by changing a destination address of message 1022 to address AN1 of access node 110 and including a converted payload portion of message 840 (shown in FIG. 8 as “conv(value)” of message 1026) as the payload portion of message 1026.

Once message 1026 has been generated, scanner device can send message 1026 to access node 110 via connection 710.

### IV. Example Access-Node User Interface

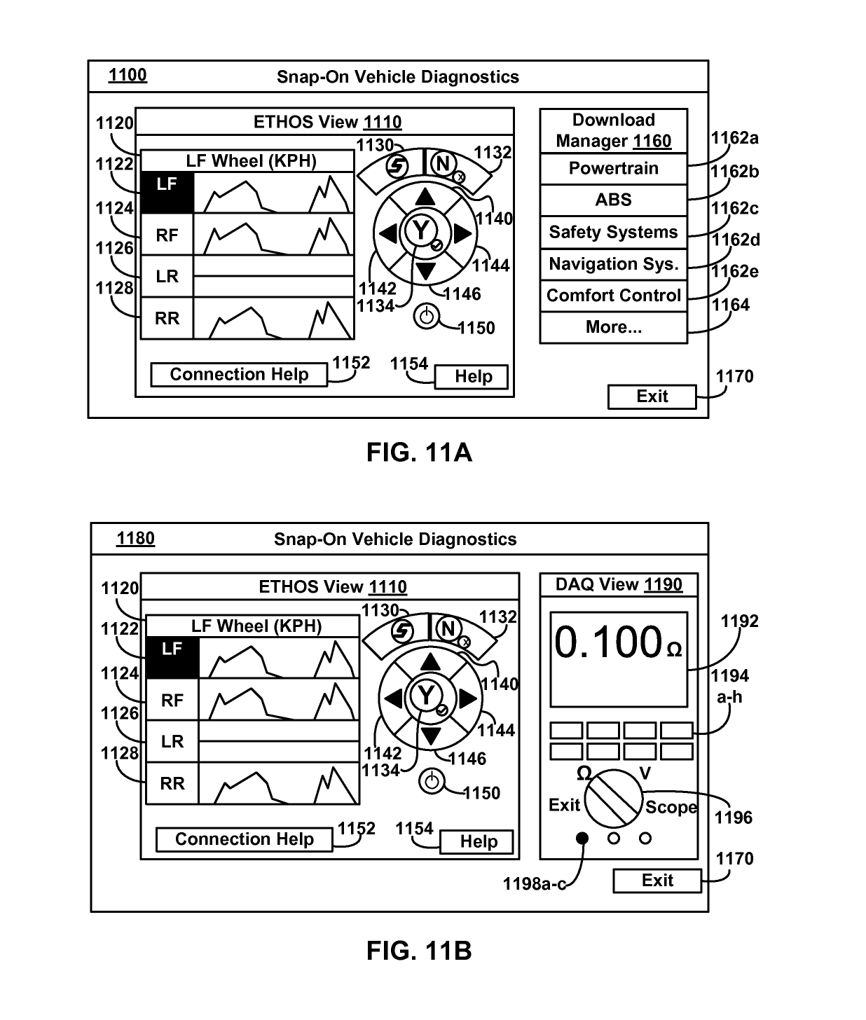

FIGS. 11A and 11B illustrate example user interfaces 1100 and 1180, respectively, for access node 106.

FIG. 11A shows user interface 1100 with ETHOS View dialog 1110 and download manager dialog 1160. User interface 1100 is configured for use with either address configuration 700 or address configuration 900.

ETHOS view dialog 1110 can be used to diagnose, investigate, and/or repair device-under-service 102. ETHOS view dialog 1110 shows diagnostic window 1120, controls 1130, 1132, 1134, 1140, 1142, 1144, 1146, and 1150, connection help button 1152, and help button 1154.

Diagnostic window 1120 can be configured to display data from one or more control units of device-under-repair 102 provided in accordance with a communication protocol. For example, data received via a diagnostic-communication protocol can be displayed in diagnostic window 1120 in graphical and/or textual form. FIG. 11A shows diagnostic window 1120 showing displays for about four wheels of a vehicle: a left-front (LF) wheel display 1122, right-front (RF) wheel display 1124, left-rear (LR) wheel display 1126, and right-rear (RR) wheel display 1128. Diagnostic window shows that the left-front wheel is selected for observation, by indicating left-front wheel display 1122 in a different format (e.g., with a black background) in comparison with other wheel displays 1124, 1126, and 1128 and by setting a title of diagnostic window 1120 to include “LF Wheel.” Other methods of showing selected displays, other types of diagnostic displays, and/or data from regarding other sub-devices of device-under-repair 102 are possible as well.

Controls 1130, 1132, 1134, 1140, 1142, 1144, 1146, and 1150 can control ETHOS view dialog 1110. In some embodiments, such as shown in FIG. 11A, diagnostic window 1120 and/or controls 1130, 1132, 1134, 1140, 1142, 1144, 1146, and 1150 can be configured to resemble displays and controls of a diagnostic device, such as the ETHOS scan tool manufactured by Snap-on Incorporated of Kenosha, Wis.

Function control button 1130 can be configured to control ETHOS view dialog 1110 settings, such as, but not limited to, colors/fonts used to display ETHOS view dialog 1110, printing/saving of data displayed in ETHOS view dialog 1110, and/or to start/stop recording of data displayed in ETHOS view dialog 1110 (e.g., movies of graphical displays).

Back-button control 1132 and accept-button control 1134 can be used to enter no or yes responses, respectively, to requests for information presented to a user of ETHOS view dialog 1110. In some embodiments, back-button control 1132 can be used to exit a particular display or menu of ETHOS view dialog 1110 and/or return to a main menu of ETHOS view dialog 1110 (not shown in FIG. 11A). Accept-button control 1134 also can be used to select a highlighted item.

Display of ETHOS view dialog 1110 can be guided by directional controls 1140, 1142, 1144, and 1146 to permit moving up, moving left, moving right, or moving down, respectively, of a selection or cursor of ETHOS view dialog 1110. For example, selection of directional control 1146 with a user input device (e.g., clicking on directional control 1146 with a mouse or selection of directional control 1146 using a touch-screen input device) can move selection of left-front wheel display 1122 down to right-front wheel display 1124. Then, selection of accept-button control 1134 can confirm selection of right-front wheel display 1124. Once the selection of right-front wheel display 1124 is confirmed, a format of left-front wheel display 1122 can be changed to utilize the same format as used by other non-selected displays (e.g., displays 1126 and 1128), a format of right-front wheel display 1124 can be displayed in a different format in comparison with other wheel displays 1122, 1126, and 1128, and a title of diagnostic window 1120 can be changed from including “LF Wheel” to include “RF Wheel.”

Exit-button control 1150 can be selected to close ETHOS view dialog 1110. Connection help button 1152 can display one or more connection diagrams configured to show a vehicle technician or other user how to connect device(s), such as, but not limited to access node 110, controller device 108, scanning device 106, DAQ device 104, and/or device-under-service 102, to permit repair, diagnosis, and/or investigation of device-under-service 102.

Help button 1154 can be selected to provide help other than connection help 1152. Example help topics include, but are not limited to, functionality supported by the user interface, usage notes, information about the user interface, software and/or hardware version information, and other information intended to guide or help with user interface 1100 and/or 1180.

Download manager 1160 can permit downloading of software from access node 110 to device-under-service 102. Download manager dialog 1160 can provide selections to download software for various types of sub-devices of device-under-service 102. For example, FIG. 11A shows selections available via powertrain software button 1162a, anti-lock braking system (ABS) software button 1162b, safety systems software button 1162c, navigation system software button 1162d, and comfort control software button 1162e. Additional software downloads can be selected by selecting more button 1164.

Upon selection of a software button, access node 110 can initiate downloading of the appropriate software to device-under-service 102. In some embodiments, software is downloaded from access node 110 to device-under-service 102 using a general-purpose communication protocol, such as an Ethernet communication protocol. As such, software to be downloaded can be divided as needed into packets or other protocol data units required by the general-purpose communication protocol and sent to device-under-service 102 via scanning device 106.

For example, if anti-lock braking system software button 1162b is selected, access node 110 can locate anti-lock braking system software and download the selected anti-lock braking system software to device-under-service 102 via scanning device 106 using the procedures described in the paragraph immediately above.

Many other applications utilizing transmission of data between access node 110 and device-under-service 102 are possible as well, such as, but not limited to communicating video data, audio data, textual data, other types of software, and/or other types of data between access node 110 and device-under-service 102. In some embodiments, video data, audio data, textual data, software, and/or other types of data can be communicated between access node 110 and scanner device 106, controller device 108, DAQ device 104, and/or some other device(s) configured to communicate with access node 110.

Exit button 1170 can be selected to close user interface 1100.

FIG. 11B shows user interface 1180 with Ethos View dialog 1110 and DAQ view dialog 1190. User interface 1180 is configured for use with address configuration 900 that permits connection to DAQ device 104.

ETHOS view dialog 1110, connection help button 1152, and help button 1154 are described above in detail in the context of FIG. 11A. As with user interface 1100, exit button 1170 can be selected to close user interface 1180.

DAQ view dialog 1190 can aid communication with DAQ device 104, perhaps to diagnose, investigate, and/or repair device-under-service 102. In some embodiments, DAQ device 104 has to be connected to scanner device 106 before user interface 1180 can display DAQ view dialog 1190. In some of these embodiments, DAQ device 104 must be configured in a “remote mode” to permit control of DAQ device 104 from a device remote from DAQ device 104 (e.g., access node 110). In other of these embodiments, when user interface 1180 cannot display DAQ view dialog 1190, user interface 1180 can display information indicating that DAQ device 104 must be connected.

In some embodiments, such as shown in FIG. 11B, DAQ view dialog 1190 can be configured to resemble displays and controls of a diagnostic device, such as the Verdict M2 diagnostic device manufactured by Snap-on Incorporated of Kenosha, Wis.

DAQ view dialog 1190 include DAQ window 1192, DAQ controls 1194a-1194h, mode selector 1196, and jack-status indicators 1198a-1198c.

DAQ window 1192 shows data from DAQ device 104, such as, but not limited to, alphanumeric data, graphical data, messages from DAQ device 104, and/or other data. For example, FIG. 11A shows DAQ window 1192 displaying a resistance measurement of 0.100 ohms (Ω).

Controls 1194a-h control DAQ display 1192 based on a mode selected by mode selector 1196. Example controls include, but are not limited to switching between absolute and relative measurements, “freezing” or stopping DAQ display 1192, changing a timescale of DAQ display 1192, display controls (e.g., color, font, etc. of DAQ view 1190), display of minimum and/maximum measurement values, control of displayed measurement precision (e.g., number of digits behind a decimal point), and switching between an alphanumeric mode, such as shown in FIG. 11B, and a graphing mode, not shown in FIG. 11B.

Mode selector 1196 permits selection of a mode, or measurement type, for DAQ device 104. Example modes shown in FIG. 11B include a resistance mode (S2), voltage mode (V), oscilloscope mode (Scope), and exit or power-down mode. Many other types of modes are possible, including but not limited to, multiple voltage modes (e.g., alternating-current-voltage mode, direct-current-voltage mode), capacitance mode, test mode(s) to verify functionality of DAQ device 104, air and/or fluid pressure mode(s), and temperature modes.

Jack-status indicators 1198a-1198c can be used to display a status of one or more input jacks used to connect input leads to DAQ device 104, as mentioned above in the context of FIG. 9. As shown in FIG. 11B, one jack-status indicator is shown to be black indicating a corresponding jack is occupied with an input lead, and two jack-status indicators are shown to be white indicating corresponding jacks are not occupied with input leads. In some embodiments not shown in FIG. 11B, jack-status indicators 1198a-1198c can indicate a connectivity status of a corresponding jack (e.g., connected, disconnected, transmitting data, short circuit, etc) by use of graphical and/or textual displays.

### V. Example Operation

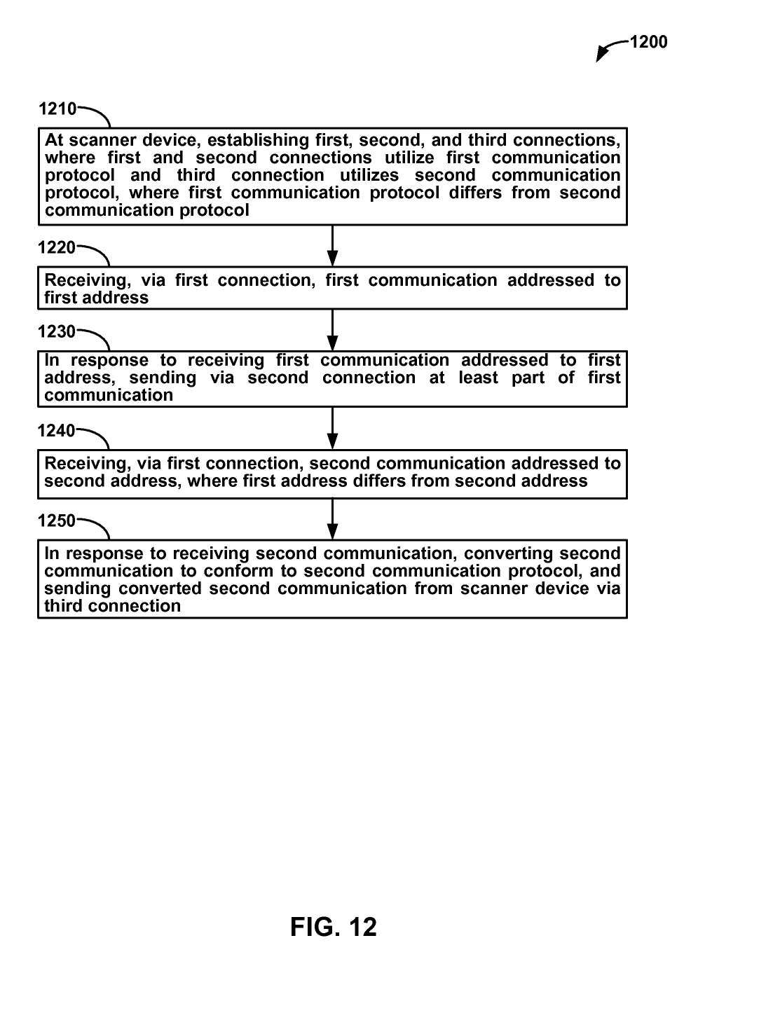

FIG. 12 depicts a flow chart that illustrates functions 1200 that can be carried out in accordance with an example embodiment. For example, the functions 1200 can be carried out by scanner device 106 described above in more detail in the context of FIGS. 1 and 2B-11B.

Block 1210 includes establishing at least a first connection, a second connection, and a third connection at a scanner device. The first and second connections can utilize a first communication protocol and the third connection can utilize a second communication protocol. The first communication protocol differs from the second communication protocol. Establishing first, second, and third connections at a scanner device is described above in more detail in the context of at least FIGS. 1, 2B, and 4-11B.

In some embodiments, the first, second, and third connections are wired connections. In other embodiments, at least one of the first, second, and third connections is a wireless connection. Wired and wireless connections are described above in more detail with respect to at least FIGS. 1-10.

In some embodiments, the first communication protocol is an Ethernet (IEEE 802.3) protocol and/or the second protocol is an On-Board Diagnostic protocol, such as OBD-II.

Block 1220 includes receiving, via the first connection, a first communication addressed to a first address. Receiving communication addressed to a scanner device is described above in more detail in the context of at least FIGS. 7-10.

Block 1230 includes sending at least part of the first communication from the scanner device via the second connection, in response to receiving the first communication addressed to the first address. Sending communications from the scanner device is described above in more detail above at least in the context of FIGS. 7-10.

Block 1240 includes receiving, via the first connection, a second communication addressed to a second address. The first address differs from the second address. Receiving communication addressed to a scanner device configured with at least two addresses is described above in more detail in the context of at least FIGS. 7-10.

Block 1250 includes in response to receiving the second communication addressed to the second address: (a) converting the second communication to conform to the second communication protocol, and (b) sending, via the third connection, the converted second communication from the scanner device. Converting and sending communications from the scanner device is described above in more detail above at least in the context of FIGS. 7-10.

In some embodiments, functions 1200 include receiving a first-communication response to the first communication utilizing the first communication protocol, via the second connection. In these embodiments, at least part of the first-communication response utilizing the first communication protocol can be sent via the first connection.

In other embodiments, functions 1200 include receiving a message utilizing the second communication protocol via the third connection. In these embodiments, the response can be converted to conform to the first communication protocol and the converted response can be sent via first connection utilizing the first communication protocol.

In still other embodiments, functions 1200 include establishing, at the scanner device, a fourth connection utilizing a third communication protocol. In these embodiments, the third communication protocol is not the first communication protocol or the second communication protocol. For example, the first protocol can be an Ethernet protocol, the second communication protocol can be an OBD-II protocol, and the third communication protocol can be a device-specific-communication protocol. In these embodiments, a third communication can be received via the first connection at the scanner device. The third communication can be addressed to a third address, where the third address differs from both the first address and the second address. The third communication can be converted to conform to the third communication protocol. The converted third communication can be sent via the fourth connection utilizing the third communication protocol.

### VI. Conclusion

Example embodiments of the present invention have been described above. Those skilled in the art will understand that changes and modifications can be made to the described embodiments without departing from the true scope and spirit of the present invention, which is defined by the claims.

We claim:

1. A method, comprising:
at a scanner device, establishing at least a first connection, a second connection, and a third connection, wherein the first and second connections utilize a first communication protocol and the third connection utilizes a second communication protocol, and wherein the first communication protocol differs from the second communication protocol;
receiving, via the first connection, a first communication addressed to a first address;
in response to receiving the first communication addressed to the first address, sending, via the second connection, at least part of the first communication from the scanner device;
receiving, via the first connection, a second communication addressed to a second address, wherein the first address differs from the second address; and
in response to receiving the second communication addressed to the second address, converting the second communication to conform to the second communication protocol, and sending, via the third connection, the converted second communication from the scanner device.

2. The method of claim 1, wherein the first connection, second connection, and third connection are each wired connections.

3. The method of claim 1, wherein the first communication protocol is an IEEE 802.3 protocol.

4. The method of claim 1, wherein the second communication protocol is an On-Board Diagnostic (OBD) protocol.

5. The method of claim 1, further comprising:
receiving, via the second connection, a first-communication response to the first communication utilizing the first communication protocol; and
sending, via the first connection, at least part of the first-communication response utilizing the first communication protocol.

6. The method of claim 1, further comprising:
receiving, via the third connection, a message utilizing the second communication protocol;
converting the response to conform to the first communication protocol; and
sending, via the first connection, the converted response utilizing the first communication protocol.

7. The method of claim 1, further comprising:
establishing, at the scanner device, a fourth connection utilizing a third communication protocol, wherein the third communication protocol differs from the first communication protocol and the second communication protocol;
receiving, via the first connection, a third communication at the scanner device addressed to a third address, wherein the third address differs from the first address and the second address;
converting the third communication to conform to the third communication protocol; and
sending, via the fourth connection, the converted third communication utilizing the third communication protocol.

8. A scanner device, comprising:
a processor;
memory;
a communication interface; and
computer-readable program instructions, stored in the memory that, upon execution, cause the scanner device to perform functions, comprising:
establishing, via the communication interface, at least a first connection, a second connection, and a third connection, wherein the first and second connections utilize a first communication protocol and the third connection utilizes a second communication protocol, and wherein the first communication protocol differs from the second communication protocol;
receiving, via the first connection, a first communication addressed to a first address,
in response to receiving the first communication addressed to the first address, sending, via the second connection, at least part of the first communication,
receiving, via the first connection, a second communication addressed to a second address, wherein the first address differs from the second address, and
in response to receiving the second communication addressed to the second address, converting the second communication to conform to the second communication protocol, and sending, via the third connection, the converted second communication.

9. The scanner device of claim 8, wherein the communication interface comprises a wired interface, and wherein the first connection, second connection, and third connection are each wired connections.

10. The scanner device of claim 8, wherein the first communication protocol is an IEEE 802.3 protocol.

11. The scanner device of claim 8, wherein the second communication protocol is an On-Board Diagnostic (OBD) protocol.

12. The scanner device of claim 8, wherein the functions further comprise:
receiving, via the second connection, a first-communication response to the first communication utilizing the first communication protocol; and
sending, via the first connection, at least part of the first-communication response utilizing the first communication protocol.

13. The scanner device of claim 8, wherein the functions further comprise:
receiving, via the third connection, a message utilizing the second communication protocol;
converting the response to conform to the first communication protocol; and
sending, via the first connection, the converted response utilizing the first communication protocol.

14. The scanner device of claim 8, wherein the functions further comprise:
establishing, via the communication interface, a fourth connection utilizing a third communication protocol, wherein the third communication protocol differs from the first communication protocol and the second communication protocol;
receiving, via the first connection, a third communication addressed to a third address, wherein the third address differs from the first address and the second address;
converting the response to conform to the third communication protocol; and
sending, via the fourth connection, the converted response utilizing the third communication protocol.

15. A computer-readable storage medium having instructions stored thereon that, upon execution by a processor of a device, cause the device to perform functions comprising:
establishing at least a first connection, a second connection, and a third connection, wherein the first and second connections utilize a first communication protocol and the third connection utilizes a second communication protocol, and wherein the first communication protocol differs from the second communication protocol;
receiving, via the first connection, a first communication addressed to a first address;
in response to receiving the first communication addressed to the first address, sending, via the second connection, at least part of the first communication from the scanner device;
receiving, via the first connection, a second communication addressed to a second address, wherein the first address differs from the second address; and
in response to receiving the second communication addressed to the second address, converting the second communication to conform to the second communication protocol, and sending, via the third connection, the converted second communication.

16. The computer-readable storage medium of claim 15, wherein the first connection, second connection, and third connection are each wired connections.

17. The computer-readable storage medium of claim 15, wherein the first communication protocol is an IEEE 802.3 protocol.

18. The computer-readable storage medium of claim 15, wherein the second communication protocol is an On-Board Diagnostic (OBD) protocol.

19. The computer-readable storage medium of claim 15, wherein the functions further comprise:
receiving, via the second connection, a first-communication response to the first communication utilizing the first communication protocol; and
sending, via the first connection, at least part of the first-communication response utilizing the first communication protocol.

20. The computer-readable storage medium of claim 15, wherein the functions further comprise:
receiving, via the third connection, a message utilizing the second communication protocol;
converting the response to conform to the first communication protocol; and
sending, via the first connection, the converted response utilizing the first communication protocol.
